(19) United States
(12) Patent Application Publication
(10) Pub. No.: US 2024/0168479 A1
(43) Pub. Date: May 23, 2024

(54) VEHICULAR WORKSITE MONITORING AND ASSISTANCE

(71) Applicant: FORD GLOBAL TECHNOLOGIES, LLC, Dearborn, MI (US)

(72) Inventors: Stuart C. Salter, White Lake, MI (US); Brendan F. Diamond, Grosse Pointe, MI (US); Meghan Preiss, Detroit, MI (US); Annette Lynn Huebner, Highland, MI (US); Lia Pillen, Woodhaven, MI (US)

(21) Appl. No.: 17/991,370

(22) Filed: Nov. 21, 2022

(51) Int. Cl. G05D 1/02; G01C 21/34; G05D 1/10

(52) U.S. Cl. CPC G05D 1/0214; G01C 21/3461; G05D 1/101

(57) ABSTRACT

A system includes a vehicle and a drone. The vehicle receives a site plan along with a plurality of points of interest and receives commands for one or more tasks to be undertaken at each point of interest. The vehicle determines whether a path between at least two of the points of interest is known and travelable by the vehicle. Also, the vehicle autonomously navigates a known path to travelable points of interest based on the determination that a travelable path exists and instructs the drone processors to launch and navigate to points of interest to which the vehicle cannot travel based on the results of the determination.

### TECHNICAL FIELD

The illustrative embodiments generally relate to methods and apparatuses for vehicular worksite monitoring and assistance.

### BACKGROUND

Worksite supervisors and entities at parent corporations may have a difficult time managing multiple projects without onsite visits. These companies must place a good deal of reliance on agents in the field, and cannot often confirm the progress of tasks except at scheduled updates and/or without site visits. It takes human resources to monitor and confirm progress on a site, and communication errors may result in that monitoring not being as full-scope as desired.

Moreover, it may not always be simple to review the progress on a site for daily tasks and with regards to all materials, planning, placement, etc. If incorrect materials are being used, a hole is dug or located incorrectly, cutouts for windows or doors are incorrectly place, etc., it may be a long time before someone notices the error. This can lead to significant down time as rebuilding may have to occur, especially if progress has gone far past a given construction point.

Often times there are business calls with a client as well, wherein the company must present the most recent review results, but those results may be stale and may not reflect current progress. Further, unless there is an active party on-site with a camera at least, the call cannot be shaped dynamically to view certain areas of interest, instead it must flow based on whatever a prior party gathered as evidence of progress. Thus, if the client wants to see the progress on an area not captured, the call must be rescheduled or the client must visit the site, creating additional delay and headache.

Engineers may also want to make dynamic changes, and must deliver blueprints, work with the builders and ensure that changes are understood and accommodated. Client changes must similarly be delivered and dealt with. This means scheduling meetings with the correct parties, and often also requires a site visit. Digging requires excavation markings in the United States, which can mean further delays. Because the jobsite is an active project away from a main location of corporate resources, it presents an ongoing challenge in the forms of at least monitoring, updating and tracking progress on the site.

### SUMMARY

In a first illustrative embodiment, a system includes a vehicle, including one or more vehicle processors and a drone, including one or more drone processors. The one or more vehicle processors are configured to receive a site plan along with a plurality of points of interest and receive commands for one or more tasks to be undertaken at each point of interest. The one or more vehicle processors are further configured to determine whether a path between at least two of the points of interest is known and travelable by the vehicle. Also, the processors are configured to autonomously navigate a known path to travelable points of interest based on the determination that a travelable path exists and instruct the one or more drone processors to launch and navigate the drone to points of interest to which the vehicle cannot travel based on the results of the determination.

In a second illustrative embodiment, a vehicle includes one or more vehicle processors configured to receive a plurality of points of interest correlated to a site plan. The one or more processors are also configured to receive commands for one or more tasks to be undertaken at each point of interest and determine whether a path between at least two of the points of interest is known and travelable by the vehicle. The one or more processors are additionally configured to autonomously navigate a known path to travelable points of interest based on the determination that a travelable path exists and execute the one or more tasks at each point of interest associated with a given one or more tasks as each point of interest is reached.

In a third illustrative embodiment, a method includes navigating a drone above a site to determine a travelable vehicle path between a plurality of points of interest, based on imagery of the site indicating obstructed or travelable paths. The method also includes creating a path, based on the travelable path and imagery, for an autonomous vehicle to travel and identifying any points of interest that are unreachable by the vehicle. Also, the method includes receiving one or more tasks for execution using at least one of drone or vehicle systems at each point of interest. The method additionally includes executing the vehicle tasks using the autonomous vehicle when the autonomous vehicle reaches each reachable point of interest along the travelable path and executing remaining tasks at the unreachable points of interest using the drone.

### BRIEF DESCRIPTION OF THE DRAWINGS

FIG. 1 shows an illustrative vehicle plus drone assistance system;

FIG. 2 shows an illustrative process for pathing and tracking progress;

FIG. 3 shows an illustrative personnel logging process;

FIG. 4 shows an illustrative progress monitoring process; and

FIG. 5 shows an illustrative assistance provision process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose a job-tracking and assistance system utilizing an onsite vehicle, which may be fully or semi-autonomous. In other instances, the vehicle may be partially or fully controllable from a remote work-station.

Modern vehicles can be provided with a variety of advanced sensing, imaging and even image projection systems. Laser headlights, for example, as described in co-pending U.S. patent application Ser. No. 17/684,882 filed Mar. 2, 2022, commonly owned and the contents of which are fully incorporated by reference herein, can be used to project images on surfaces at a jobsite. This can include laser levels for use in tracking level runs across wide spans, and can even include projection of an image or a blueprint design on a wall, showing where various job tasks are to be completed. Effectively, this can template a wall with a laser in a dynamic fashion. The same projection can also be used to verify that features are placed in correct locations, are placed correctly relative to each other, and that a finished stage conforms to a planned design. To the extent it does not, mistakes can be quickly identified and rectified.

These vehicles can also travel around a site and dynamically and continually track progress. They represent a mobile power and transport source, able to bring, energy, tools, supplies and even food to various site locations to keep the job moving. They can travel open paths on the site, providing monitoring and assistance as needed. Through remote communication with an off-site party, they can function as virtual conference centers, allowing (through vehicle cameras, for example) viewing of the project and active discussion through vehicle communication systems.

Some vehicles may even include launchable and controllable drones, such as described in commonly owned and co-pending U.S. patent application Ser. No. 17/659,851 filed Apr. 20, 2022, the contents of which are fully incorporated herein by reference. These drones can relay data back to a vehicle on-site, and can travel within areas of the site, or above the site, at locations where the vehicle often cannot go. This allows for close-viewing of various hard-to-reach areas, as well as navigation through building interiors, upper building cover areas, second stories, etc. The drones may be provided with some assistance aspects of the vehicle as discussed herein, and drone capabilities in terms of assistance, transport and monitoring are mostly a matter of design choice. The illustrative embodiments contemplate drones capable of delivering materials, projecting images, and generally performing most functions ascribed to the vehicles herein as well, although such drones with full capability may be heavy and expensive and may also be foregone for smaller drones with more limited capabilities.

As described herein, the onsite vehicle can be used to monitor progress, dynamically provide assistance, and preserve a continual presence at the site, to catch issues prior to them becoming a larger problem and to help keep everyone communicating and on task.

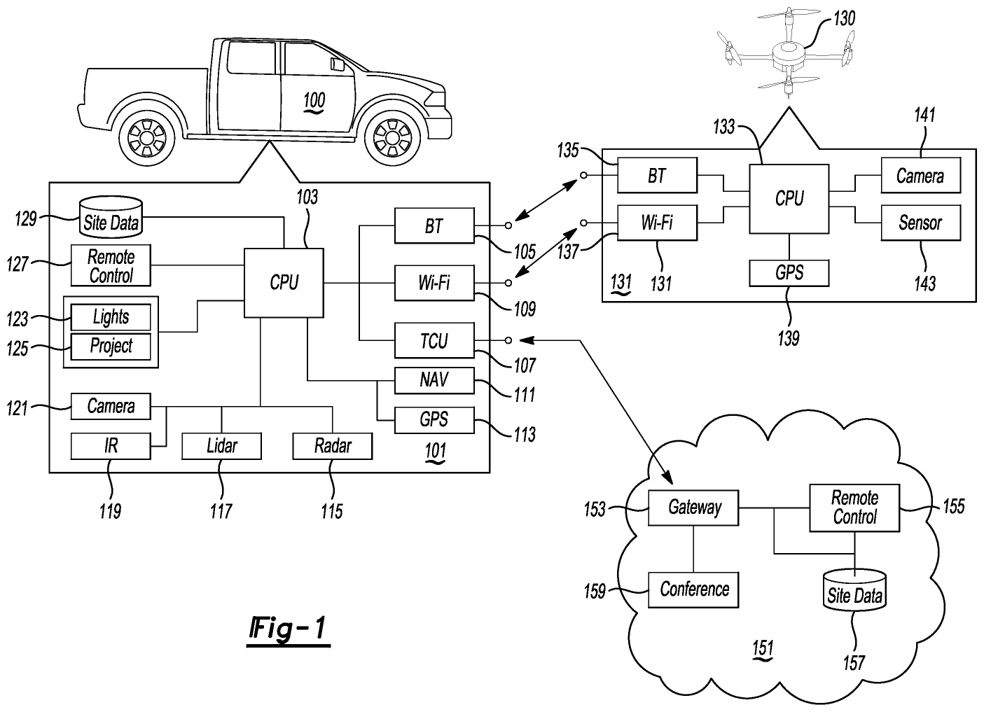

FIG. 1 shows an illustrative vehicle plus drone assistance system. In this example, the vehicle 100 includes an onboard computing system 101, which has one or more processors 103, and a variety of communication channels. These channels can include, for example, BLUETOOTH via transceiver 105, Wi-Fi via transceiver 107 and a telematics control unit 109. The BLUETOOTH and Wi-Fi channels may be used for communication with on-site devices, which can include worker devices and/or the drone or drones. Data can be relayed to the vehicle 100 from drone 130 over the appropriate channel. The TCU 109 can be used for longer range cellular communication, which can enable upload of onsite videos and findings, as well as remote control of the vehicle from a remote source, when enabled.

The vehicle 100 may also include navigation process 111 and a GPS or other geo-positioning sensor 113. This can be used to navigate the vehicle fully or partially autonomously around a site, and can be used to confirm vehicle locations correspond to desired points of interest (POIs) at a given site. If the GPS receiver has sufficient definition, highly precise coordinate placement of laser markings can be provided on-site for manual marking and/or guidance. For example, working with an real time kinematic (RTK) beacon, vehicles can be positioned within 1 cm of a desired location, allowing for precise deployment of location markings and projected images. A drone, for example, could track a laser marking and spray paint or stake an exact location (assuming the drone had the appropriate capability). Or a human could travel to the marked location and place a more permanent marker, such as a flag, stake, paint, etc.

Precise location technology also allows the vehicle to “mark” underground lines with visual projected markings, which can then be marked by humans. The vehicle may know the exact locations of the various underground lines and can mark them (via image) with both depth and location. A human can then hand-mark the corresponding lines, preventing a long wait for city services to come to a site to mark lines. Because the vehicle knows or can know where lines are located, this can also serve as a spot check that a project under observation is not headed for an encounter with an unmarked or mis-marked line—the vehicle may be able to observe the trajectory of excavation and realize that a line will be encountered, and notify an appropriate party before the line is struck.

In other instances, the vehicle can remain on-site while excavation occurs, to assist throughout the course of excavation and guide excavation around the underground and hidden obstacles.

The vehicle 100 may also include a variety of sensors, such as RADAR 115, LIDAR 117, infrared 119, cameras 121, etc. These sensors can be used in various capacities to track onsite progress. Cameras can image builds, and use image comparison and/or other AI and ML processes to compare progress to what is expected. Paint drips, breaks, cracks, etc. can be discerned from imaging. Images of laser plans laid out on a wall which has undergone construction can provide a fast reference for comparison, the camera can easily see if a laser marking indicates a hole where one is not, or vice versa. The vehicle 100 can log all relevant data and immediately contact a site manager and/or upload the data for scheduling a fix of a job that has an error identified by the vehicle 100.

Radar can be used for ranging purposes to measure dimensions, and LIDAR can be used to build 3D point clouds of objects on-site to track shapes and dimensions, as well as relative placement. IR sensors can sense inappropriate heat and other hidden situations.

As noted before, the vehicle 100 may include complex laser headlights 123 capable of full image projection on a site space via projection programming 125. This can include, but is not limited to, projection of laser level lines on a wall on multiple axes, projection of a blueprint or grid with cutout locations marked and dimensions of various features projected directly onto a work surface, projection of holes, lines and other markings for excavation, including dimensions and precise measurements in the form of both the image and the attendant markings, or even a projection of a full-color image that can show what a finished design is supposed to look like, for example. The vehicle may even be able to project an ongoing video conference on a wall, allowing for the vehicle to effectively act as a projector for facilitating a video chat. Images may be repositioned by moving the vehicle and/or re-aiming the lighting, depending on how the vehicle is equipped.

The vehicle 100 may also include a remote control feature 127, allowing for full or partial remote control of the vehicle 100 from a remote source. Onboard sensors and other backup systems can help ensure that the remote control of the vehicle does not encounter an unintended obstacle or object. Site data, such as plans, personnel, material lists, blueprints, line locations, etc. may be stored in an object database 129, providing the vehicle 100 with a full set of data as to what is supposed to be occurring and where, at the site. This data can also be updated as the vehicle 100 travels the site, so that a record of progress can be kept with regards to relevant elements of the site data—e.g., successful excavation around lines can be stored with the line data, so the project manager knows that the appropriate locations were dug without incident, and can see exactly where the locations were dug in real or near-real time.

In some embodiments, the vehicle 100 may include a launchable or paired drone 130. This drone can have simple cameras and/or more advanced sensing and capabilities. In the example shown, the drone 130 includes an onboard computing system 131. This has one or more processors 133, as well as BLUETOOTH 135 and Wi-Fi transceivers 137. These can be used to communicate with the vehicle 100 and/or onsite devices. The drone may have some autonomous steering capability, such as pathing and obstacle circumvention. Using onboard sensors 143 and/or cameras 141, the drone 130 may be able to navigate around a site to areas where a vehicle 100 cannot go. Further, the drone may be used to map a path for the vehicle from overhead, as it can fly up and generally determine where a clear path around the site exists.

While a vehicle 100 could path through a site using trial and error with sensors, the drone 130 may be able to lay out a much more clear path. Construction sites change profile constantly, with earth, equipment and materials moving around on a daily basis. This means that prior pathing may not still exist, and so the drone 130 can be used to dynamically map a path for a vehicle 100 to navigate the site. For example, a drone can track several GPS points of interest using onboard GPS 139. The drone can view a visible path for a vehicle from one POI to the next, and the vehicle or an operator can use this information to navigate through the site.

The vehicle 100 may also communicate with the cloud 151, which can include relay of information from the drone if the drone cannot communicate with the cloud directly. Power may be in shorter supply in a drone, given weight constraints, and the vehicle 100 can serve as a relay for information to preserve the power that would otherwise be spent on a cellular connection.

The cloud may handle myriad requests, and so may include a gateway 153 for request and response routing. In this example, the gateway 153 handles routing of requests and responses for conferencing 159. This can include sending information to the vehicle for headlight display or use of vehicle displays to show a video conference. The vehicle can output audio through vehicle speakers and/or onsite devices and respond with audio collected from on-site devices and/or microphones.

The cloud 151 may also provide remote control support 155, which can be tied in with a site data database 157, so the operator knows what is being worked on. If the vehicle 100 keeps the site database 159 updated, this can provide a near real-time live map of the site so the operator can know where the travelable routes are and what is currently under progress.

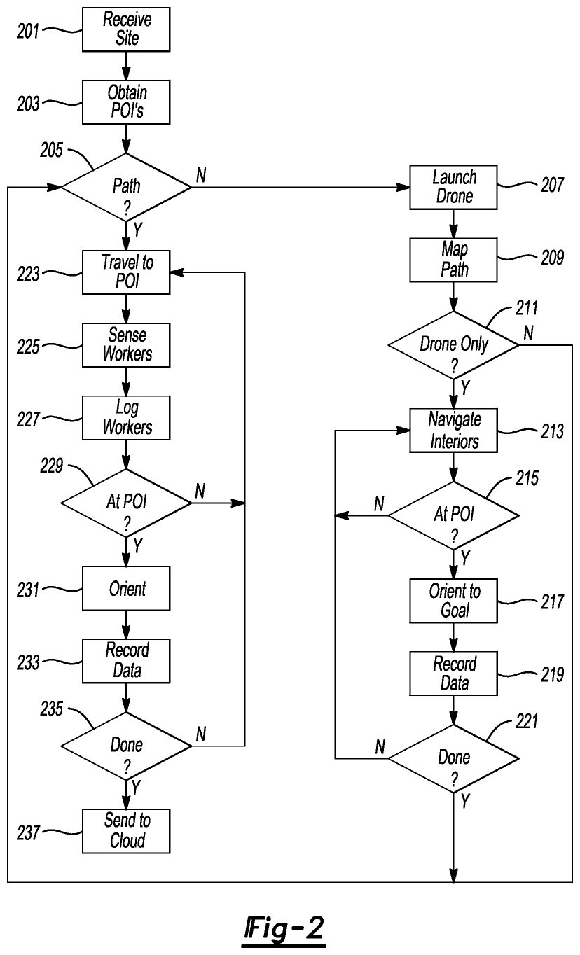

FIG. 2 shows an illustrative process for pathing and tracking progress. The vehicle 100 in this example receives a site instruction at 201. This can include a location where the vehicle 100 is already on-site, or a new location. Since the vehicles 100 can travel from site to site, they may monitor more than one site on a daily basis. They can also be re-tasked to new sites if there is a site that needs monitoring in particular. This allows a fleet of fewer vehicles than sites to service all sites for a company, assuming each site does not require a dedicated vehicle 100.

Since the vehicle 100 in this example will be performing a service on-site, it receives a list of POIs at 203. The vehicle can travel to each POI to perform a designated task. Onsite vehicles may also be dynamically purposed to deliver tools, loads, power, lunch, etc., through a remote request from personnel onsite or a remote party.

Depending on site conditions, the vehicle 100 may be able to determine if a path is already known whereby the vehicle 100 can travel to each POI. If the path exists at 205, the vehicle 100 can survey the site. If the path does not exist, cannot be fully completed by the vehicle (e.g., includes a POI the vehicle cannot possibly reach, such as a building top), and/or if the path status is unknown, the vehicle 100 can launch a drone at 207. The drone 130 may communicate with the vehicle and be fully or partially controllable from a vehicle console. The drone may also be capable of autonomous or semi-autonomous flight.

The drone may also have navigation capability, so when the drone receives the POIs it can map a path through the site at 209, by flying high above the site for example. Clear pathways for vehicles 100 can be marked, and cluttered pathways can be observed more closely to determine clearances. This can allow the drone to build a swift path to vehicle-accessible points, as well as determine points that the drone should survey because the vehicle cannot.

If there are no drone-only points at 211, the process can revert to having the vehicle 100 perform examination of the site. The drone can also observe points a vehicle can reach, so whether a drone or vehicle performs the observation or service may be a matter of choice, but typically the vehicle 100 will have better sensors, better load capability, better battery, etc. and may be the entity of choice for site review. On the other hand, the drone can perform observational tasks while the vehicle hauls material around the site or performs other assistance, so in some instances the drone may perform the tasks when they are generally observational in nature.

If the drone is to perform any of the surveying or assistance at 211, the drone may navigate to the sites, which may include self or guided navigation through building interiors at 213 or above buildings until a POI is reached at 215. The drone can also possibly travel faster than the vehicle, in more linear paths, and through buildings, so it may be more efficient to do a large scale review of small details using a drone instead of a vehicle 100.

Once the drone reaches a POI at 215, the drone may have to orient towards a goal at 217. Depending on the aiming of cameras and sensors, the drone may need to be positioned relative to the goal (object of interaction). The drone may also be better equipped than the vehicle to reorient, and even if a vehicle can reach a POI, the vehicle may have difficulty aiming a camera at an appropriate area based on vehicle orientation, whether the cameras are fixed, and how far the cameras can pan if they are not fixed. The drone can then record the relevant data at 219 or perform another task, until all drone-survey points are completed at 221.

When the vehicle 100 is performing the survey, it can travel to the POI at 223 using a known or drone-identified path. The vehicle may sill encounter obstacles along this path, so obstacle circumvention may be engaged to carefully navigate the vehicle throughout the site. The drone may not always be able to identify an obstacle from above (e.g., a raised concrete portion the same color as surroundings), so the vehicle 100 can also attempt to circumvent obstacles through sensor usage.

While the vehicle 100 travels, it can log the presence and general locations of workers. Workers may be provided with mobile devices having unique signatures and/or some form of RF badging. If the vehicle 100 senses a wireless signal associated with a worker while it travels at 225, the vehicle 100 can log a location associated with the worker at 227. This can be the vehicle 100 location, a location broadcast from a worker ID or device, or a general site region (e.g., area A, area B, etc.). This is a useful way to determine whether personnel are where they are supposed to be, and can also be used to identify anyone who may be in distress, if they are located in a region where no one is supposed to be, or if they are persistently located in a location where they do not seem to be moving about, but should be.

Once the vehicle 100 reaches the POI at 229, it can orient to a goal at 231 similar to the drone. This can involve aiming the vehicle, aiming cameras or sensors, etc. Cameras may be independently steerable, but vehicle lighting may have limited aiming generally confined to a front of a vehicle. Thus, if the vehicle 100 is intended to provide projection, it may need to be forwardly aimed at a wall or surface of interest. The vehicle 100 can also record data (or provide other services) at 233, traveling to each POI, tracking workers and assisting until the full set of POIs is complete at 235. It is worth noting that the vehicle 100 and drone 130 may work in parallel. Once all data is collected for the site, it can be uploaded to the cloud at 237. Upload can also be continual throughout data gathering and/or triggered based on events, such as something being out of line with a plan.

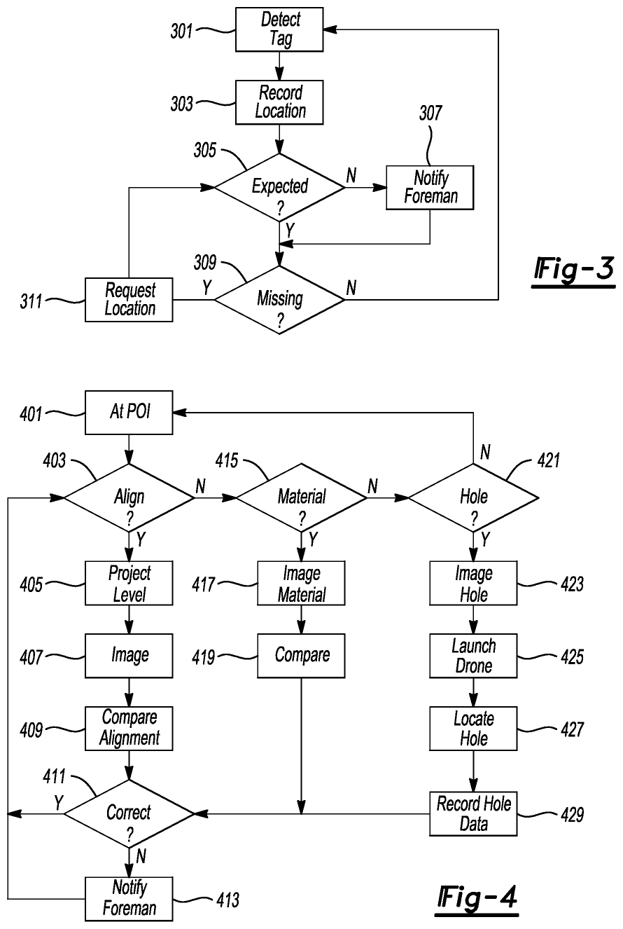

FIG. 3 shows an illustrative personnel logging process. As previously noted, employees onsite can wear badges or carry RF transmitters allowing vehicles to specifically or generally identify and track employee locations. This can be useful for both ensuring people are where they are supposed to be and ensuring no one is where they should not be. As each ID detected at 301, the vehicle 100 can log a location at 303, associated with the vehicle 100 or the ID if the ID can transmit a more specific location. The location may also include the vehicle location and a heading to the tag, if directional sensing is possible.

When the possessor of the ID is where they are expected to be at 305, the vehicle 100 can continue on its path. If they are not where they are expected to be, the vehicle 100 can notify a foreman at 307. This can be using a cellphone on site or other device carried by the foreman with which the vehicle can communicate.

If an expected tag is not found at 309, that is, if the employee appears to be missing from one or more areas where they are expected to be, the process can attempt to contact the employee at 311 to request a location. This can be useful to determine if someone has fallen down a hole or has otherwise become stuck in a difficult situation preventing their presence where expected. If the employee can or does respond with an all clear and/or confirmation of a location, the process can continue. Otherwise, the process could notify a foreman at 307 and/or dispatch a drone if deemed necessary to assist in finding anyone presumably missing.

FIG. 4 shows an illustrative progress monitoring process. This example shows several non-limiting instances of site monitoring possible with a vehicle 100. These are examples only, and it will be appreciated that more monitoring than this can occur, based on vehicle capabilities. In this example, the vehicle 100 has at least one monitoring task associated with a POI to which it is to travel or to which it is navigated. Once at the POI at 401, the vehicle 100 examines the task(s) to be performed.

If the task is an alignment related task at 403, which in this example is to use a laser or imaging to check the alignment of one or more objects or features, the vehicle 100 can project a laser level against the object(s) at 405. As noted, this can be done using laser headlamps. Even if the vehicle lacks such capability, however, the vehicle 100 may still be able to check alignment. For example, in an image, a known level wall or adjacent feature may be checked against a horizontal or vertical axis of an object to determine if they are level, such as by drawing a line in an image across the multiple points. Perspective can skew the image, so the reference feature should be in a similar plane and/or have similar orientation to the object in question. Levels can also be estimated by comparing, for example, two sides of an opening for consistency in height. By checking distance from the ground and vertical distance, as it appears in the image, it can be possible to determine if an opening is square, or rectangular, for example. Again, perspective can skew the image, so camera orientation head-on may be required in some circumstances.

In this example, the vehicle projects a level across the feature and images the result at 407. The alignment of the feature is compared to the alignment of the level at 409. Again, perspective may play a role, as well as elevation if there is a change across a feature, so care may be taken to correctly align the level and camera to obtain a true perspective. If the feature appears correct, the process can continue at 411, otherwise it can notify a foreman or responsible party at 413.

If there is an apparent error, the vehicle 100 can issue an onsite notification and display the level and/or a blueprint projected on the wall or surface showing how things should be aligned. This can allow for swift rectification and understanding of an improper variance.

In another example, the vehicle 100 may be monitoring material or tool usage at 415. Since the vehicle 100 may generally be able to compare materials, but cannot, for example, necessarily analyze the composition of a material, the vehicle 100 can generally evaluate whether a material is the proper material based on imaging (e.g., asphalt looks much different from concrete). The vehicle 100 can image the material being or having been deployed at 417 and compare the image to a reference image or reference characteristics (roughness, color, etc.).

This analysis can also extend to techniques being used and order of operations analysis. For example, certain techniques may have significantly different visual characteristics than others, and the vehicle can likely do a limited comparison between two possible choices without significant recourse to visual analysis. With regards to order of operation, the vehicle may confirm, based on knowledge from prior analysis or results, that a prior step was completed or undertaken before a current subsequent observed step.

When analyzing tool usage, the vehicle 100 may be more adept at determining precise usage, being able to potentially identify heavy equipment (e.g., cement mixers or steamrollers) as well as hand tools. If, for example, a parking lot is designated as concrete, and there is a shortage of cement mixers and a presence of steamrollers, the vehicle 100 may notify a party that there appears to be an intent to deploy the wrong surface material.

The vehicle 100 can also evaluate excavation, such as holes and other dug features at 423. The vehicle 100 can position itself near a hole, for example, and project a laser image of the hole atop the actual hole. If the laser image is the correct size based on projection distance and vehicle location, and the laser exceeds the hole size, then the hole is too small. If the laser does not exceed the hole, this does not mean the hole is correct, but the vehicle 100 can increment the projected size to quickly determine if the hole is too large—a correctly sized hole should almost immediately result in projection overlap if the projection is increased in size.

In this example, the vehicle may not be in a great position to image the hole while projecting the hole, so it locates the hole at 423 and images the hole. Then it launches a drone at 425 and, for example, projects the intended hole size. The drone flies until over the hole at 427, where it can look down upon the hole and check a dimension of the hole based on the laser at 429. Other techniques can be used to determine hole size, and the suitability of a given technique may depend both on available capability and the actual size of the excavation. For example, a drone could fly the borders of a 50×50 foot square foundation hole to determine that it was the correct size based on drone coordinates, which can be used to map the foundation or other excavation using breadcrumbs or lines connecting reported coordinates.

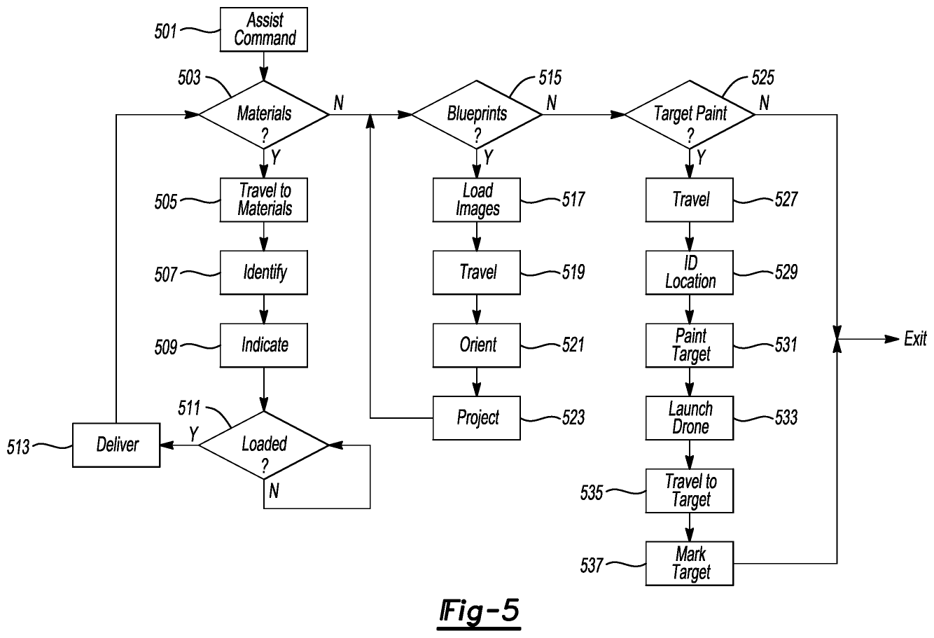

FIG. 5 shows an illustrative assistance provision process. These are several non-limiting examples of how a vehicle 100 can assist on a site. When the vehicle 100 receives an assistance command, it can determine what type of assistance is needed. Because transportation is at least one possible need, the command may be analyzed before the vehicle 100 begins moving, in case it requires transportation from the present site to a POI.

If the command is a material load assist command at 503, the vehicle 100 can travel to a yard portion of a site at 505 where materials may be located. The vehicle 100 may be able to identify what material is needed (e.g., wood vs. structural light steel) based on material appearance. The vehicle 100 can also project the requested load onto a surface for review by onsite personnel, if the vehicle 100 cannot self-load or load using robots.

In this example, the vehicle 100 identifies a base material or tool at 507 and then projects an indicate of how much is needed at 509 on the pallet or tool storage—e.g., projecting “10 12′ 6×2″ beams” on a pile of beams or the ground adjacent the pile, or projecting “rotary hammer” on a tool storage shed. Once the load is loaded at 511, the vehicle can travel to the POI where dropoff is to occur at 513.

In another example, the vehicle 100 provides projection assistance at 515. This involves the vehicle 100 traveling to a site POI. The vehicle 100 can load images to be projected at 517 and travel to the location of interest at 519. Once onsite, the vehicle 100 can orient itself to correctly project the image at 521. Human operators may also adjust a vehicle location if necessary, although in some instances the vehicle may be able to more precisely manuver itself than a human could. Once in location, the vehicle 100 can project a level or blueprint on a surface to assist onsite personnel.

In still a further example, the vehicle can “paint” a target for marking at 525, similar to painting a target for weapons deployment. That is, the vehicle 100 can travel to a POI where it can see a target with its laser. The target can be virtually anything, including walls, ground surfaces, etc.

The vehicle 100 identifies the specific location of interest at 529 while onsite and paints the target with a laser visible by a drone at 531. This is useful for autonomous site marking when personnel are not around—a vehicle and drone working together can mark a site plan on surfaces overnight, and the next day workers can arrive with the work laid out.

In this example, the drone includes either a paint (actual paint) deployment module, a staking module (e.g., hydraulic staking), or other capability to permanently or temporarily physically mark the target object. Guided by the painted target, which can include a layout or other 2-D or multi-dimensional marking in laser, the drone travels to the target at 535 and marks the target accordingly at 537. Drones may be able to use temporary upfit modules for such purposes, switching between paint for marking walls and stakes for marking ground features. Once any requested assistance is completed, the process exits.

In the manners proposed, and in similar circumstances, the vehicle and/or drone combination can serve a useful role as an onsite presence, capable of monitoring, assisting, updating, communicating and generally creating a better sense of and control over onsite progress.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
a vehicle, including one or more vehicle processors; and
a drone, including one or more drone processors; wherein
the one or more vehicle processors are configured to receive a site plan along with a plurality of points of interest;
receive commands for one or more tasks to be undertaken at each point of interest;
determine whether a path between at least two of the points of interest is known and travelable by the vehicle;
autonomously navigate a known path to travelable points of interest based on the determination that a travelable path exists; and
instruct the one or more drone processors to launch and navigate the drone to points of interest to which the vehicle cannot travel based on the results of the determination.

2. The system of claim 1, wherein the one or more vehicle processors are further configured to:
search for radio frequency identification of personnel while the vehicle travels on a site indicated by the site plan; and
record locations associated with any detected radio frequency identification.

3. The system of claim 1, wherein the commands include a projection assistance task and the one or more vehicle processors are further configured to:
determine the vehicle has reached a point of interest associated with the projection assistance task;
orient the vehicle so that laser headlamps of the vehicle are correctly oriented to project an image accurately along a surface at the point of interest; and
use the laser headlamps to project the image upon the surface.

4. The system of claim 3, wherein the image includes one or more level lines.

5. The system of claim 3, wherein the image includes at least a portion of a blueprint to be applied to the surface.

6. The system of claim 1, wherein the commands include an evaluation task and wherein the one or more vehicle processors are further configured to:
determine the vehicle has reached the point of interest;
orient a vehicle sensor to capture a surface indicated by the evaluation task;
obtain sensor data related to the surface from the vehicle sensor; and
evaluate the sensor data to determine if the surface matches a goal indicated in the evaluation task.

7. The system of claim 6, wherein the one or more drone processors are further configured to obtain the sensor data using a drone sensor oriented to the surface, responsive to a command from the vehicle and to wirelessly convey the data to the vehicle for evaluation.

8. The system of claim 1, wherein the one or more drone processors are configured to launch and navigate the drone above the points of interest to determine whether a vehicle path exists, responsive to the vehicle not being able to determine a known path between at least two of the points of interest.

9. The system of claim 8, wherein the vehicle path is determined based at least on imagery of a portion of a site indicated by the site data, usable to determine if a passable vehicle path exits based on clearances indicated by the imagery.

10. A vehicle comprising:
one or more vehicle processors configured to:
receive a plurality of points of interest correlated to a site plan;
receive commands for one or more tasks to be undertaken at each point of interest;
determine whether a path between at least two of the points of interest is known and travelable by the vehicle;
autonomously navigate a known path to travelable points of interest based on the determination that a travelable path exists; and
execute the one or more tasks at each point of interest associated with a given one or more tasks as each point of interest is reached.

11. The vehicle of claim 10, wherein the one or more vehicle processors are further configured to:
search for radio frequency identification of personnel while the vehicle travels on a site indicated by the site plan; and
record locations associated with any detected radio frequency identification.

12. The vehicle of claim 10, wherein the commands include a projection assistance task and the one or more vehicle processors are further configured to:
determine the vehicle has reached a point of interest associated with the projection assistance task;
orient the vehicle so that laser headlamps of the vehicle are correctly oriented to project an image accurately along a surface at the point of interest; and
use the laser headlamps to project the image upon the surface.

13. The vehicle of claim 12, wherein the image includes one or more level lines.

14. The vehicle of claim 12, wherein the image includes at least a portion of a blueprint to be applied to the surface.

15. The vehicle of claim 10, wherein the commands include an evaluation task and wherein the one or more vehicle processors are further configured to:
determine the vehicle has reached the point of interest;
orient a vehicle sensor to capture a surface indicated by the evaluation task;
obtain sensor data related to the surface from the vehicle sensor; and
evaluate the sensor data to determine if the surface matches a goal indicated in the evaluation task.

16. The vehicle of claim 15, wherein the one or more vehicle processors are further configured to project an image for comparison on the surface, using vehicle headlamps, prior to obtaining the sensor data.

17. The vehicle of claim 16, wherein the projected image is shaped to be the same size and shape as an intended result, when displayed on the surface, and wherein the sensor data includes camera data indicating whether an actual feature of the surface is a correct size and shape based on the projected image laid atop the feature.

18. A method comprising:
navigating a drone above a site to determine a travelable vehicle path between a plurality of points of interest, based on imagery of the site indicating obstructed or travelable paths;
creating a path, based on the travelable path and imagery, for an autonomous vehicle to travel;
identifying any points of interest that are unreachable by the vehicle;
receiving one or more tasks for execution using at least one of drone or vehicle systems at each point of interest;
executing the vehicle tasks using the autonomous vehicle when the autonomous vehicle reaches each reachable point of interest along the travelable path; and
executing remaining tasks at the unreachable points of interest using the drone.

19. The method of claim 18, further comprising:
identifying at least one point along a path where imagery indicates possible obstruction;
navigating the drone to a closer vantage point of the at least one point; and
evaluating the possible obstruction using drone sensors to determine if the autonomous vehicle can pass the obstruction.

20. The method of claim 18, further comprising:
identifying at least one error at one point of interest based on at least one evaluation task executed at the at least one point of interest; and
using a vehicle headlamp system to project a correction to the at least one error on a surface on which the at least one error was identified as existing.
